(19) United States
(12) Patent Application Publication
(10) Pub. No.: US 2026/0322254 A1
(43) Pub. Date: Oct. 15, 2026

(54) STARTUP CONTROLLER FOR POWER CONVERSION APPARATUS

(71) Applicant: SANSHA ELECTRIC MANUFACTURING CO., LTD., Osaka (JP)

(72) Inventors: Hiroshi FUKUI, Osaka (JP); Kazuhiro NISHIKAWA, Osaka (JP); Takeshi MORIMOTO, Osaka (JP)

(73) Assignee: SANSHA ELECTRIC MANUFACTURING CO., LTD., Osaka (JP)

(21) Appl. No.: 19/641,028

(22) Filed: Apr. 7, 2026

(30) Foreign Application Priority Data
Apr. 10, 2025 (JP) 2025-065270

(51) Int. Cl. H02M 1/36; H02M 3/335

(52) U.S. Cl. CPC H02M 1/36; H02M 3/33573

(57) ABSTRACT

Provided is a startup controller for a power conversion apparatus capable of uniformizing the quality of direct current in a period immediately after the activation of the power conversion apparatus. A startup controller for a power conversion apparatus performs switching control after converting an alternating current into a primary direct current. The startup controller includes a system voltage detection circuit that detects a specific phase in an input of the alternating current, and a switching controller that executes the switching control at a unique timing specified by the phase detected by the system voltage detection circuit in response to an input from an activation switch.

### BACKGROUND OF THE INVENTION

### 1. TECHNICAL FIELD

The present invention relates to a startup controller for a power conversion apparatus.

### 2. DESCRIPTION OF THE RELATED ART

As a power-supply apparatus that supplies power from a commercial power supply to electric equipment, there has conventionally been proposed an apparatus based on a timing control circuit in the power-supply apparatus (see JP 2009-176263 A for example). This power-supply apparatus is an apparatus intended to reduce an inrush current that flows when the power is turned on.

Meanwhile, a power conversion apparatus used for short-time welding obtains a direct-current output by using a commercial alternating-current power supply as an alternating-current input. The power conversion apparatus typically performs switching control based on pulse width modulation (PWM) control through input of an activation switch from the outside. The alternating-current input is rectified and smoothed before switching control, and converted into a direct-current output on the primary side.

The operation of the power conversion apparatus starts from the input of the activation switch through the operation of the user, and the starting point can be generated at any timing with respect to the phase of the alternating-current input that is the commercial alternating-current power supply. In other words, the timing of the activation of the power conversion apparatus is not uniquely determined in the phase of the alternating-current input.

### SUMMARY OF THE INVENTION

However, this has been found to cause the following problems. That is, in the power conversion apparatus, when the phase timing of the alternating-current input is different, the voltage at the time of smoothing on the primary side is different. Thus, the rising waveform of the direct-current output on the secondary side extracted by the power conversion apparatus differs depending on the phase timing. This means that the same current waveform cannot be obtained immediately after the activation of the power conversion apparatus, that is, variability in quality of the direct current immediately after the activation of the power conversion apparatus is generated in the conventional power conversion apparatus.

The current waveform (quality) of the direct-current output is uniquely stabilized after a lapse of a predetermined time. Thus, the variability has not been a problem until now in use of a load to which a normal power conversion apparatus is connected. However, the short-time welding is performed using the period immediately after the activation of the power conversion apparatus. Thus, the variability in the quality of the direct current directly affects the welding. That is, the variability in the quality of the direct current causes the variability in the quality of the welding.

Thus, a main object of the present invention is to solve the above-described problem and to uniformize the quality of the direct current in the period immediately after the activation of the power conversion apparatus.

A startup controller for a power conversion apparatus according to the present invention is an startup controller for a power conversion apparatus, the startup controller being configured to perform switching control after converting an alternating current into a primary direct current, the startup controller including a phase detector that detects a specific phase in an input of the alternating current, and a switching control unit that executes the switching control based on the phase detected by the phase detector and an input from an activation switch.

In the startup controller for a power conversion apparatus according to the present invention, the switching controller is executed with a specific phase detection time detected by the phase detector as a starting point. Thus, the same current waveform is obtained immediately after the activation of the power conversion apparatus. That is, the quality of the direct current can be made uniform in the period immediately after the activation of the power conversion apparatus. This makes it possible to perform power conversion suitable for short-time welding.

In addition, in the startup controller for a power conversion apparatus according to the present invention, when the phase detector is a zero crossing detection circuit, switching control can be easily performed at a unique timing of phase.

The present invention can provide a startup controller for a power conversion apparatus capable of uniformizing the quality of direct current in a period immediately after the activation of the power conversion apparatus.

The above-described object, other objects, features, and advantages of the present invention will further be made clear by the following description of modes for carrying out the invention, which description is made with reference to the drawings.

### BRIEF DESCRIPTION OF THE DRAWINGS

FIG. 1 is a diagram illustrating a configuration example of a power conversion apparatus including a startup controller according to an embodiment of the present invention;

FIG. 2 is a block diagram illustrating a configuration example of a power conversion apparatus including the startup controller according to the embodiment of the present invention;

FIG. 3 is a block diagram schematically illustrating an internal configuration of a zero crossing detection circuit which is an example of a system voltage detection circuit constituting the startup controller according to the embodiment of the present invention;

FIG. 4 is a diagram illustrating temporal changes of an output current in a rising section and a working time;

FIG. 5 is a diagram illustrating a difference with respect to a temporal change of a voltage waveform in the rising section due to a difference in phase at the time of output; and

FIG. 6 is a diagram illustrating a difference with respect to a temporal change of a waveform of an output current due to a difference in phase at the time of output.

### DETAILED DESCRIPTION

Hereinafter, a power conversion apparatus according to the present invention will be described.

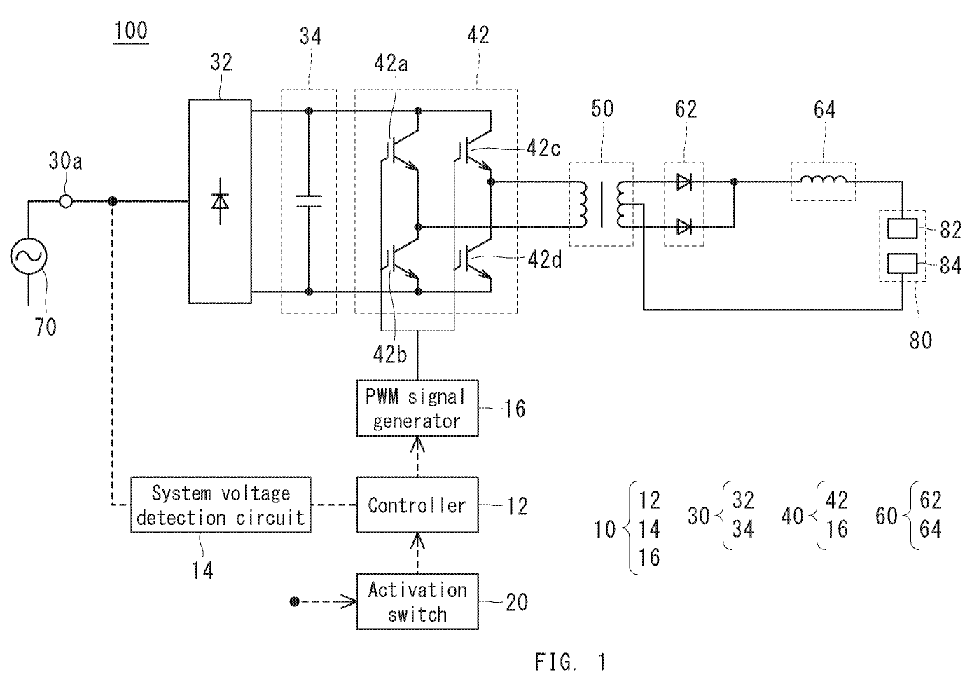

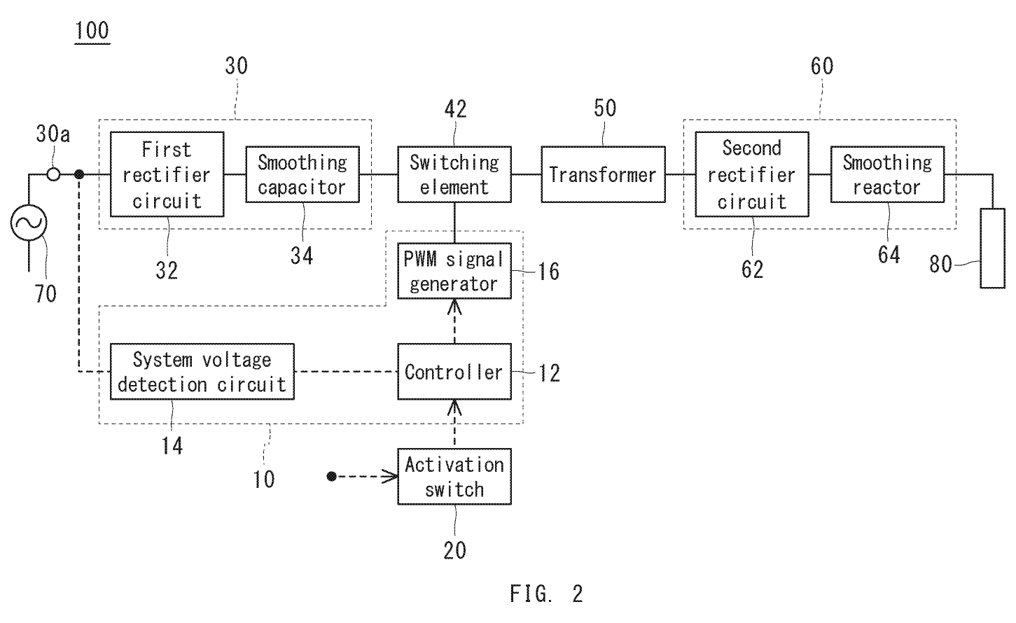

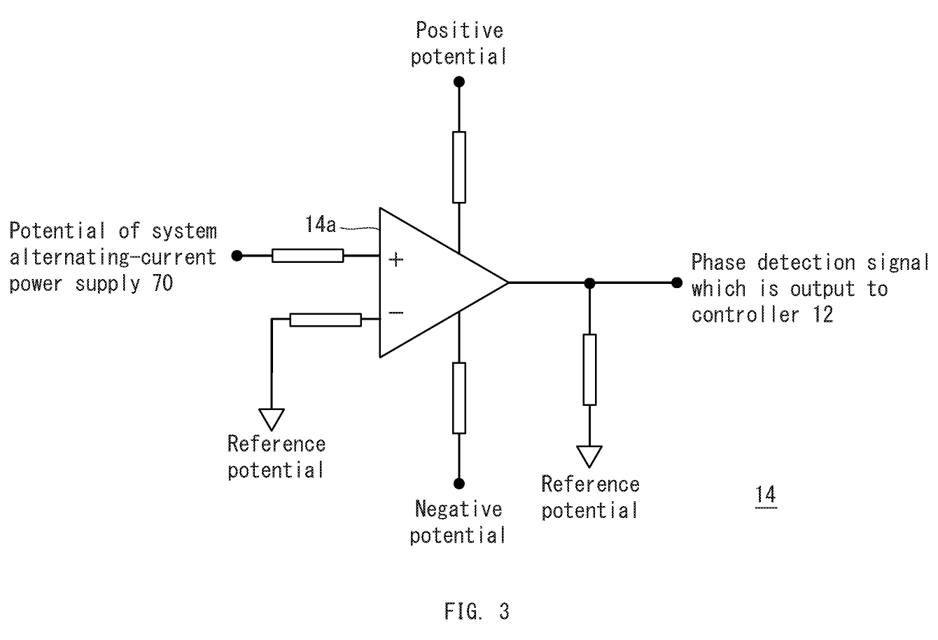

FIG. 1 is a diagram illustrating a configuration example of a power conversion apparatus including a startup controller according to an embodiment of the present invention. FIG. 2 is a block diagram illustrating a configuration example of the power conversion apparatus including the startup controller according to the embodiment of the present invention. FIG. 3 is a block diagram schematically illustrating an internal configuration of a zero crossing detection circuit which is an example of a system voltage detection circuit constituting the startup controller according to the embodiment of the present invention.

### 1. Power Conversion Apparatus

A power conversion apparatus 100 includes a startup controller 10, a primary current generator 30 that rectifies and smooths an alternating current to obtain a primary direct current, a switching controller 40 that performs switching control on the primary direct current to obtain a rectangular wave current, a transformer 50 that is a transformer that transforms the rectangular wave current, and a secondary current generator 60 that rectifies and smooths the rectangular wave current transformed by the transformer 50 to obtain a secondary direct current. The output current to be output to a load 80 is controlled by performing PWM control on the switching controller 40. The load 80 is, for example, a welding load, comprising a welding electrode 82 called a torch and a welding base material 84 to be processed.

The switching controller 40, the transformer 50, and the secondary current generator 60 constitute a DC-DC converter.

The primary current generator 30 is a unit that receives an input of alternating-current power from a system alternating-current power supply 70 and converts the alternating-current power into a primary direct current. As the transformer of the present invention, the transformer 50 connects the primary current generator 30 and the secondary current generator 60 via the switching controller 40. The transformer 50 is a unit that transforms the voltage of the primary current, which is the output of the primary current generator 30, and outputs the transformed current as a secondary current to the secondary current generator 60.

The secondary current generator 60 is a unit that receives the input of the transformed rectangular wave current from the transformer 50, rectifies the rectangular wave current, and outputs the rectified rectangular wave current as a secondary direct current. The switching controller 40 has a function of making the phase of the power to be output to the transformer 50 constant with a PWM control signal from a PWM signal generator 16 described later. The operation of the switching controller 40 will be described in detail later.

The power conversion apparatus 100 of the present invention converts the system alternating-current power supply 70 supplied from the outside into a direct-current voltage and supplies stable power to the load. The system alternating-current power supply 70 is, for example, a commercial power supply, and the supply voltage varies depending on the region, but generally has voltage specifications such as a single-phase 100 V (50 Hz or 60 Hz), a single-phase 200 V (50 Hz or 60 Hz), and a three-phase 200 V (50 Hz or 60 Hz). In industrial equipment, three-phase 400 V (50 Hz or 60 Hz) may be used. The alternating-current power supply is not limited to a commercial power supply, and an alternating-current power supply such as an alternating-current voltage supplied from a generator or an uninterruptible power supply (UPS) or a renewable energy source (for example, an inverter output generated through wind power generation or solar power generation) can also be used.

### Startup controller

The startup controller 10 is a startup controller 10 for the power conversion apparatus 100 that performs switching control after converting an alternating current into a primary direct current. The startup controller 10 includes a controller 12, a system voltage detection circuit 14 that is a phase detector, and a PWM signal generator 16 that is a switching control unit.

The controller 12 has a function of controlling the system voltage detection circuit 14 and the PWM signal generator 16. When an activation switch 20 is turned on, an activation signal from the activation switch 20 is input to the controller 12. Then, the controller 12 instructs the system voltage detection circuit 14 to specify the phase. Then, the controller 12 generates an activation command signal based on the phase detection signal output from the system voltage detection circuit 14 and the signal generated when the activation switch 20 is turned on, and outputs the activation command signal to the PWM signal generator 16.

The system voltage detection circuit 14 has a function of detecting a specific phase at the input of an alternating current. Specifically, the system voltage detection circuit 14 has a function of detecting a zero crossing point of the alternating-current signal input to the primary current generator 30 and performing predetermined control based on the zero crossing point. The system voltage detection circuit 14 outputs a phase detection signal when detecting a specific phase in the input of the alternating current according to an instruction from the controller 12 to which the activation signal is input from the activation switch 20. At this time, in the specific phase detection, the offset can be freely set from zero to one cycle.

As the system voltage detection circuit 14, a zero crossing detection circuit, a peak detection circuit, or a waveform capturing circuit can be used. The zero crossing detection circuit has a function of detecting a zero crossing of a system voltage. The peak detection circuit has a function of detecting a peak voltage of a system voltage. The waveform capturing circuit has a function of detecting the waveform of a system voltage as it is. Among these, the system voltage detection circuit 14 is preferably a zero crossing detection circuit. This is because, by detecting the zero crossing, switching control can be easily performed at a unique timing of phase, which is an object of the present invention.

As illustrated in FIG. 3, the zero crossing detection circuit which is an example of the system voltage detection circuit 14 includes a comparator 14a. The comparator 14a compares the signal to be detected with a reference potential, and in the present embodiment, zero potential (0 V) is set as the reference potential. The comparator 14a outputs a high level (H) signal when the signal to be detected exceeds the reference potential, and outputs a low level (L) signal when the signal to be detected falls below the reference potential. As a result, the output signal of the comparator 14a transitions between a high level and a low level every time the signal to be detected passes through the zero crossing point. The phase detection signal generated by the zero crossing detection circuit in the present invention is input to the controller 12.

The PWM signal generator 16 has a function of causing a switching element 42 described later to execute switching control at a unique timing specified by the phase detected by the system voltage detection circuit 14 in response to the input from the activation switch 20. Based on the activation command signal output from the controller 12 that has generated the activation command signal based on the phase detection signal output from the system voltage detection circuit 14 and the signal generated when the activation switch 20 is turned on, the PWM signal generator 16 outputs a PWM control signal for performing PWM controlling on the switching element 42 to the switching element 42. The output PWM control signal is input to the gate terminal of the switching element 42.

### Primary current generator

The primary current generator 30 of the power conversion apparatus 100 of the present invention has a function for rectifying the alternating current input from the system alternating-current power supply 70 via a power supply terminal 30a as desired, and it converts the alternating current into a primary direct current, and supplies the direct current to the switching controller 40. The primary current generator 30 includes a first rectifier circuit 32 and a smoothing capacitor 34.

The first rectifier circuit 32 is a circuit that converts an alternating current into a direct current, and it is comprised of a bridge rectifier including a plurality of diodes. Specifically, a full-wave rectifier circuit that generates a direct-current component using both positive and negative voltage waveforms of an alternating-current power supply is employed.

As the first rectifier circuit 32, for example, a bridge diode circuit can be used, with which the input alternating current is converted into a current having a direct-current component. As the diode used in the first rectifier circuit 32, a Schottky barrier diode having a low loss characteristic, a fast recovery diode having a high withstand voltage characteristic, or the like can be appropriately selected.

The smoothing capacitor 34 reduces a ripple component of the direct current obtained by the first rectifier circuit 32, and supplies a more stable direct current to the transformer 50 via the switching controller 40. The smoothing capacitor 34 is comprised of, for example, an electrolytic capacitor or a film capacitor. The capacitance value is appropriately set depending on the ripple component of the input current and the load conditions. In particular, in the case of coping with a large current load, voltage fluctuation can be suppressed by using a large capacity electrolytic capacitor, and stable operation of the power conversion apparatus 100 can be secured.

### Switching Controller

The switching controller 40 is comprised of the PWM signal generator 16 described above and the switching element 42.

The switching element 42 is a semiconductor element for controlling the output timing of the rectangular wave current to be input to the transformer 50 based on the PWM control signal from the PWM signal generator 16. Specifically, as illustrated in FIG. 1, the switching element 42 includes, for example, four switching elements 42a to 42d. The switching element 42 is comprised of a bridge circuit using the switching elements 42a to 42d.

In the PWM control performed by the switching element 42, the switching elements 42a to 42d used in the present invention play an important role for precisely controlling the signal switching operation. The PWM control adjusts the average value of the output voltage by turning on and off the switching element 42 within a certain period. As the switching elements 42a to 42d used in the present invention, normally, a well-known and conventional power device capable of switching operation, such as an insulated gate bipolar transistor (IGBT) or a metal-oxide-semiconductor field-effect transistor (MOSFET) can be used. IGBT and MOSFET have high on and off switching speeds and enable precise frequency and duty ratio control in PWM control. In the PWM control of the present invention, by controlling the switching timing of on and off of the switching elements 42a to 42d based on the PWM control signal from the PWM signal generator 16, a rectangular wave current can be output at a unique timing. In the PWM control, an appropriate gate drive circuit is provided to drive the switching elements 42a to 42d. In particular, in the case of IGBT, the voltage applied to the gate terminal (gate drive voltage) greatly affects the switching speed. With a suitable gate drive circuit, fast switching and efficient operation of the switching elements can be achieved.

### Secondary Current Generator

The secondary current generator 60 of the power conversion apparatus 100 of the present invention has a function of receiving an input of the transformed rectangular wave current from the transformer 50, rectifying the rectangular wave current, and outputting the direct current as a secondary direct current. The secondary current generator 60 includes a second rectifier circuit 62 and a smoothing reactor 64.

The second rectifier circuit 62 is a circuit that converts an alternating-current input voltage into a direct current voltage, and is comprised of a bridge rectifier including a plurality of diodes. Specifically, a full-wave rectifier circuit that generates a direct-current component using both positive and negative voltage waveforms of the alternating-current input voltage from the transformer 50 is employed. As the second rectifier circuit 62, for example, a bridge diode circuit can be used. As the diode used in the second rectifier circuit 62, a Schottky barrier diode having a low loss characteristic, a fast recovery diode having a high withstand voltage characteristic, or the like can be appropriately selected.

The smoothing reactor 64 is an element for smoothing direct-current (pulsating current) power which is a rectangular wave rectified by the second rectifier circuit 62. The smoothing reactor 64 is a unit for obtaining constant voltage direct-current power, and is specifically implemented as a smoothing circuit which is a combination of a choke coil and a capacitor. The voltage applied to the smoothing reactor 64 is output to the load 80.

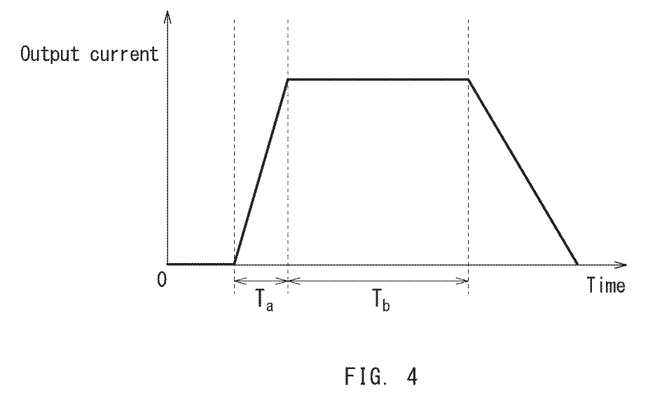

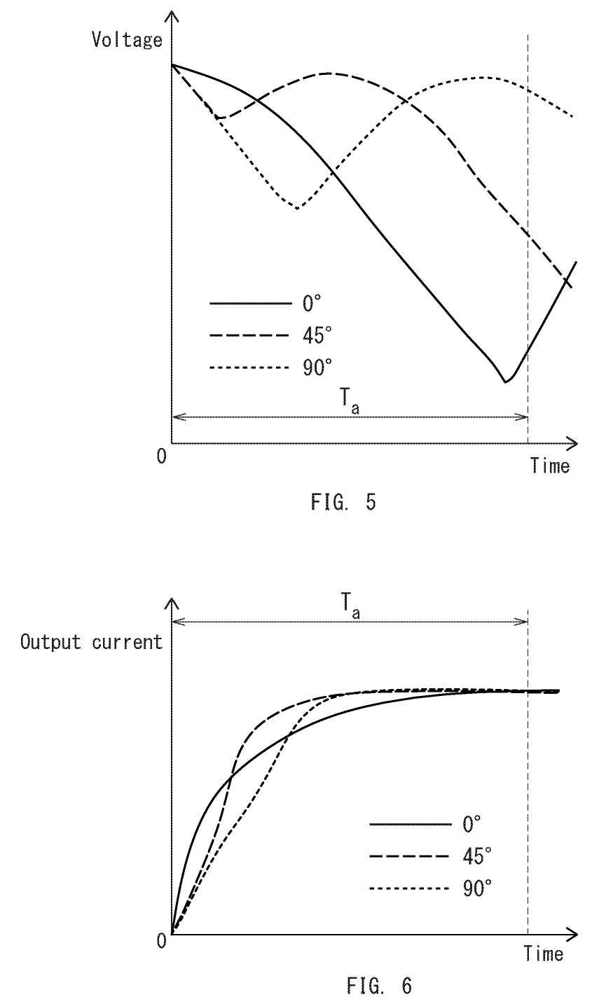

FIG. 4 is a diagram illustrating temporal changes of an output current in a rising section and a working time. FIG. 5 is a diagram illustrating a difference with respect to a temporal change of a voltage waveform in the rising section due to a difference in phase at the time of output. FIG. 6 is a diagram illustrating a difference with respect to a temporal change of a waveform of an output current due to a difference in phase at the time of output.

In the power conversion apparatus according to the present invention, as illustrated in FIG. 4, the rising section Ta has a short time of 2 ms, and the working time Tb also has a relatively short time of 5 ms or more and 20 ms or less.

In addition, when the activation switch 20 is turned on, a difference occurs in the voltage waveform in the smoothing capacitor 34 on the primary side in response to the phase of the voltage input from the system alternating-current power supply 70. FIG. 5 illustrates voltage waveforms of phases 0°, 45°, and 90° in the rising section Ta. Such a difference occurs because of the difference in the phase of the voltage, and thus, the output current in the rising section Ta also has a difference in the waveform of the output current in response to the phase, as illustrated in FIG. 6. Thus, the rising waveform of the output power is different between the phases, and thus, when welding is used as a load such as the load 80, there is a problem that the welding quality is not uniform.

In particular, it is required to uniformize the quality of welding particularly for welding in iron and steel and small parts, and it is important to uniformize the quality of welding for welding of thin plates such as steel plates of vehicles.

Thus, according to the startup controller 10 for the power conversion apparatus 100 according to the present invention, since the voltage waveform of the smoothing capacitor 34 on the primary side when the phase is 0° can be the same every time by always controlling the switching controller 40 at a unique timing specified by the phase detected by the system voltage detection circuit 14, for example, at the phase of 0°, the rising output current on the secondary side can have the same waveform every time. As a result, the output is always constant even in the period immediately after the activation. Thus, for example, there is no unevenness in the quality of welding, and thus, the quality can be made uniform, and power conversion suitable for short-time welding can be performed.

### 2. Activation Method Using Startup controller For Power Conversion Apparatus

Next, an activation method using the startup controller 10 for the power conversion apparatus 100 according to the present invention will be described.

First, when the activation switch 20 is turned on, the activation signal is input to the controller 12.

Next, the controller 12 instructs the system voltage detection circuit 14 to detect the phase. Then, the system voltage detection circuit 14 detects a specific phase and outputs a phase detection signal to the controller 12 when the timing of the set phase arrives.

An activation command signal is generated based on the activation signal from the activation switch 20 and the phase detection signal from the system voltage detection circuit 14 input to the controller 12, and the activation command signal is output to the PWM signal generator 16.

Subsequently, the PWM signal generator 16 outputs a PWM control signal to the switching element 42 based on the activation command signal from the controller 12.

In the switching element 42, the switching element 42 is controlled based on the PWM control signal from the PWM signal generator 16. Specifically, the PWM control signal is output from the PWM signal generator 16 to the gate terminal of each of the switching elements 42a to 42d.

In this manner, according to the activation method using the startup controller 10 for the power conversion apparatus 100, by starting the output at the timing of the set phase, the voltage waveform of the smoothing capacitor 34 on the primary side can have the same waveform every time, and thus, the rising output current on the secondary side can also have the same waveform every time. That is, the quality of the direct current can be made uniform in the period immediately after the activation. This makes it possible to perform power conversion suitable for short-time welding.

### Modifications

In the description made above, a case in which the system alternating-current power supply is a single-phase alternating current has been described. However, the system alternating-current power supply may be a three-phase alternating current.

In this case, the timing of becoming zero is different for each phase, and thus, the phases do not become zero at the same time. Because of this, the output value can be predicted in advance by selecting any one phase and using the phase as a reference.

In addition, the phase of each of the three phases is fixed, and the output current can be made constant by setting the zero crossing of one selected phase as a reference and outputting the phase detection signal as the timing of the set phase.

In addition, two phases of the three phases may be selected, the system voltage detection circuit 14 may detect the timing at which the phase becomes zero with reference to these phases, and phase detection signals may be output when the timings of the respective specific phases are reached. This makes it possible to perform the phase timing more accurately.

The embodiment of the present invention has been disclosed herein by the description made above, but the present invention is not limited to this embodiment.

That is, various changes can be made with respect to the mechanism, shape, material, quantity, position, arrangement, and the like with respect to the embodiment and each modification described above without departing from the scope of the technical idea and object of the present invention, and these changes are included in the present invention.

What is claimed is:

1. A startup controller for a power conversion apparatus, the startup controller being configured to perform switching control after converting an alternating current into a primary direct current, the startup controller comprising:
a phase detector that detects a specific phase in an input of the alternating current; and
a switching control unit that executes the switching control at a unique timing specified by the phase detected by the phase detector in response to an input from an activation switch.

2. The startup controller for a power conversion apparatus according to claim 1, wherein the phase detector is a zero crossing detection circuit.

3. A power conversion apparatus comprising:
a primary current generator that rectifies and smooths an alternating current to obtain a primary direct current;
a switching controller that performs switching control on the primary direct current to obtain a rectangular wave current;
a transforming unit that transforms the rectangular wave current;
a secondary current generator that rectifies and smooths the rectangular wave current transformed by the transforming unit to obtain a secondary direct current; and
the startup controller for a power conversion apparatus according to claim 1.

4. A power conversion apparatus comprising:
a primary current generator that rectifies and smooths an alternating current to obtain a primary direct current;
a switching controller that performs switching control on the primary direct current to obtain a rectangular wave current;
a transforming unit that transforms the rectangular wave current;
a secondary current generator that rectifies and smooths the rectangular wave current transformed by the transforming unit to obtain a secondary direct current; and
the startup controller for a power conversion apparatus according to claim 2.
